(19) United States
(12) Patent Application Publication
(10) Pub. No.: US 2015/0020018 A1
(43) Pub. Date: Jan. 15, 2015

(54) Method, Apparatus, Terminal And Storage Medium For Inputting Information

(71) Applicant: TENCENT TECHNOLOGY (SHENZHEN) COMPANY LIMITED, Shenzhen City (CN)

(72) Inventors: Qing WANG, Shenzhen City (CN); Zhanghu LUO, Shenzhen City (CN); Zefeng HUANG, Shenzhen City (CN); Haoran GUO, Shenzhen City (CN); Quanhao XIAO, Shenzhen City (CN); Yixia YUAN, Shenzhen City (CN); Jiashun SONG, Shenzhen City (CN); Pengtao LI, Shenzhen City (CN); Yunfeng DAI, Shenzhen City (CN); Xunchang ZHAN, Shenzhen City (CN); Chunyou LIN, Shenzhen City (CN)

(21) Appl. No.: 14/501,197

(22) Filed: Sep. 30, 2014

Related U.S. Application Data
(63) Continuation of application No. PCT/CN2013/072997, filed on Mar. 21, 2013.

(30) Foreign Application Priority Data
Apr. 6, 2012 (CN) 201210099607.0

(51) Int. Cl. G06F 3/0488

(52) U.S. Cl. CPC G06F 3/04886
USPC 715/773

(57) ABSTRACT

Disclosed is a method, an apparatus, a terminal and a storage medium for inputting information and belongs to the telecommunications field. The method for inputting information includes: monitoring a state of an inputting box, wherein the state includes an active state or a sleep state; if it is detected that the inputting box is in the active state, calling a virtual keyboard; and inputting information in the inputting box using predefined keys of the virtual keyboard. The apparatus includes a monitoring module, a calling module, and an inputting module. The terminal includes a processor, a memory, and program modules. The storage medium stores the program modules.

### CROSS-REFERENCE TO RELATED APPLICATIONS

This application is a continuation of International Patent Application No. PCT/CN2013/072997, filed on Mar. 21, 2013. This application claims the benefit and priority of Chinese Patent Application No. 201210099607.0, filed on Apr. 6, 2012. The entire disclosures of each of the above applications are incorporated herein by reference.

### FIELD

The present disclosure relates to telecommunications techniques and, more particularly, to a method, an apparatus, a terminal and a storage medium for inputting information.

### BACKGROUND

This section provides background information related to the present disclosure which is not necessarily prior art.

With the development of telecommunications techniques and smart terminals, the cell phone has become an indispensable communication tool for people. With the popularization of cell phones, various cell phone applications have emerged, often followed by Trojan viruses. In conventional techniques, when a user inputs an account/password, the Trojan virus monitors the user's keyboard input operation to steal the account and password of the user. Thus, the user information is leaked and the security level of the user information is decreased.

### SUMMARY

This section provides a general summary of the disclosure, and is not a comprehensive disclosure of its full scope or all of its features.

Examples of the present disclosure provide a method, an apparatus, a terminal, and a storage medium for inputting information, so as to increase the security level of user information.

According to various examples of the present disclosure, a method for inputting information is provided. The method includes the following:

monitoring, by a terminal, a state of an inputting box, wherein the state comprises an active state or a sleep state;

if the terminal detects that the inputting box is in the active state, calling a virtual keyboard; and

inputting, by the terminal, information in the inputting box using predefined keys of the virtual keyboard.

According to various embodiments of the present disclosure, an apparatus for inputting information is provided. The apparatus is applied in a terminal and includes the following:

a monitoring module, adapted to monitor the state of an inputting box, wherein the state includes an active state or a sleep state;

a calling module, adapted to call a virtual keyboard if it is detected that the inputting box is in the active state; and

an inputting module, adapted to input information in the inputting box according to predefined keys of the keyboard.

According to various embodiments of the present disclosure, a terminal for inputting information is provided. The terminal includes: one or more processors and one or more program modules stored in a memory, wherein the one or more program modules include instructions executable by the one or more processors to perform the following acts of:

monitoring a state of an inputting box, wherein the state includes an active state or a sleep state;

if it is detected that the inputting box is in the active state, calling a virtual keyboard; and

inputting information in the inputting box using predefined keys of the virtual keyboard.

According to various embodiments of the present disclosure, a non-transitory storage medium is provided. The non-transitory computer readable storage medium includes a set of instructions for inputting information. The set of instructions directs at least one processor to perform the following acts of:

monitoring a state of an inputting box, wherein the state includes an active state or a sleep state;

if it is detected that the inputting box is in the active state, calling a virtual keyboard; and

inputting information in the inputting box using predefined keys of the virtual keyboard.

It can be seen from the above technical solution that the state of the inputting box is monitored. If it is detected that the inputting box is in an active state, a virtual keyboard is called. Information may be input in the inputting box via predefined keys of the virtual keyboard. The present disclosure detects information input through calling the virtual keyboard of the terminal, instead of using a public keyboard (i.e., a physical keyboard or a system keyboard of the terminal). Thus, the leakage of user information due to being tapped through the public keyboard can be avoided. The security level of the user information is increased.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Figures used in the descriptions of the following examples or existing techniques are briefly introduced herein to make the technical solution of the present disclosure clearer. It should be noted that the following figures are merely some examples. Those skilled in the art will understand many variations according to these figures without an inventive work.

FIG. 1 is a flowchart illustrating a method for inputting information according to various embodiments of the present disclosure.

FIG. 2 is a flowchart illustrating a method for inputting information according to various embodiments of the present disclosure.

FIG. 3 is a diagram illustrating a structure of an apparatus for inputting information according to various embodiments of the present disclosure.

FIG. 4 is a diagram illustrating a structure of an apparatus for inputting information according to various embodiments of the present disclosure.

FIG. 5 is a diagram illustrating a structure of an apparatus for inputting information according to various embodiments of the present disclosure.

FIG. 6 is a diagram illustrating a terminal for inputting information according to various embodiments of the present disclosure.

Corresponding reference numerals indicate corresponding parts throughout the several views of the drawings.

### DETAILED DESCRIPTION

The present disclosure is described in further detail hereinafter with reference to accompanying drawings and examples to make the technical solution and merits therein clearer.

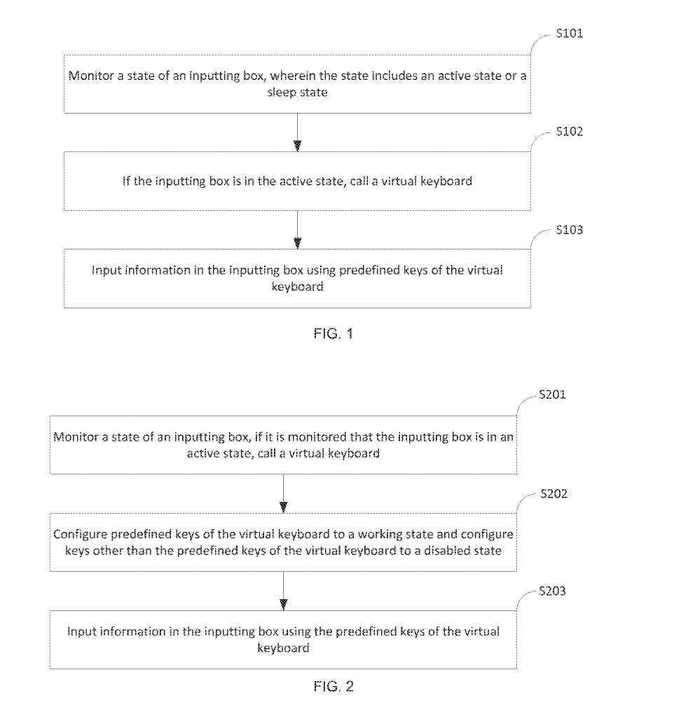

FIG. 1 is a flowchart illustrating a method for inputting information according to various embodiments of the present disclosure. The execution body of this example may be a terminal, such as a cell phone or a personal computer (PC), but is not limited any such example. In various embodiments, a predefined application refers to an application program installed in the terminal. The application program may be a system inbuilt application software of the terminal or application software downloaded and installed by the terminal. When using the application software, a user needs to input the account/password. For example, the application software has a communication function or a browsing function.

The method for inputting information includes the following. At block S101, a state of an inputting box is monitored, wherein the state includes an active state or a sleep state. At block S102, if it is detected that the inputting box is in the active state, a virtual keyboard is called. At block S103, information is input in the inputting box using predefined keys of the virtual keyboard.

The monitoring the state of the inputting box may include monitoring whether an activation operation is performed to the inputting box by an application program. If it is detected that the predefined application program activates the inputting box, determine whether the inputting box is in the active state.

The monitoring of the state of the inputting box may also include determining whether a keyboard calling command transmitted by an application program is received. If the keyboard calling command transmitted by the predefined application program is received, determine whether the inputting box is in the active state. The inputting box may include an account inputting box or a password inputting box.

The process of inputting information in the inputting box using the predefined keys of the virtual keyboard includes inputting account information in the inputting box using the predefined keys of the virtual keyboard or inputting password information in the inputting box using the predefined keys of the virtual keyboard.

Before inputting information in the inputting box using the predefined keys of the virtual keyboard, the method may further include:

configuring the predefined keys of the virtual keyboard to a working state and configuring keys other than the predefined keys of the virtual keyboard to a disabled state.

In various embodiments, the predefined keys include a left shift key, a determination key, and a right shift key.

In various embodiments, the state of the inputting box is monitored. When it is determined that the inputting box is in the active state, the virtual keyboard is called. According to the predefined keys of the virtual keyboard, information is input in the inputting box. Various embodiments of the present disclosure realize information input via calling a virtual keyboard, instead of using a public keyboard (i.e., a physical keyboard or a system keyboard of the terminal). Thus, the leakage of user information due to being tapped through the public keyboard can be avoided. The security level of the user information is increased.

FIG. 2 is a flowchart illustrating a method for inputting information according to various embodiments of the present disclosure. In various embodiments, the execution body may be a terminal, such as a cell phone or a personal computer (PC), but is not limited these. In various embodiments, a predefined application refers to an application program installed in the terminal. The application program may be a system inbuilt application software of the terminal or application software downloaded and installed by the terminal. When using the application software, a user needs to input the account/password. For example, the application software has a communication function or a browsing function. A background program in this example refers to a program that users cannot reach directly. It may be a program loaded when a system starts for implementing operations such as monitoring the predefined application program, calling the virtual keyboard, or inputting information.

The method for inputting information includes the following.

At block S201, a state of an inputting box is monitored, if it is detected that the inputting box is in an active state, a virtual keyboard is called. In various embodiments, the virtual keyboard is also referred to as a “soft keyboard”. It is a keyboard manipulated by software. It may be regarded as a secure and independent virtual keyboard. It is different from a public keyboard of the terminal, i.e., a physical keyboard of the terminal or a system keyboard of the terminal. Using the virtual keyboard, information leakage brought out by inputting account information or password information using the public keyboard, which may be recorded by a Trojan virus, can be avoided.

In block S201, the inputting box may be an account inputting box or a password inputting box. The state of the inputting box includes an active state or a sleep state. Under the active state, the inputting box receives input information. Under the sleep state, information cannot be input in the inputting box.

The background program of the terminal monitors the state of the inputting box in real time. In particular, the background program of the terminal may monitor whether there is a predefined application program that performs an activation operation to the inputting box. If it is detected that there is an application program that performs an activation operation to the inputting box, it is determined that the inputting box is in the active state. Alternatively, the background program of the terminal may monitor whether a keyboard calling command transmitted by the predefined application program is received. If it is monitored that the keyboard calling command transmitted by the predefined application program is received, it is determined that the inputting box is in the active state.

When the predefined application program activates the account inputting box/password inputting box to respectively input account information/password information, the account inputting box/password inputting box is in the active state. The background program of the terminal may detect this operation. Thus, the background program of the terminal may initiatively call the virtual keyboard for the inputting box.

In various embodiments, it is also possible to detect whether a keyboard calling command transmitted by the predefined application program is received to determine whether the inputting box is in the active state. At this time, the background program of the terminal calls the virtual keyboard passively. In particular, when activating the account inputting box/password inputting box to respectively input account information/password information, the predefined application program transmits a keyboard calling command to the background program of the terminal. After receiving the keyboard calling command, the background program of the terminal calls the virtual keyboard according to the keyboard calling command.

At block S202, predefined keys of the virtual keyboard are configured to a working state, and keys other than the predefined keys of the virtual keyboard are configured to a disabled state.

The predefined keys in various embodiments include a left shift key for a left shift operation, a right shift key for right shift operation, and a determination key for determination operation. The predefined keys may be any three keys on the virtual keyboard. In order to improve the user's experience, the determination key may be respectively adjacent to the left shift key and the right shift key.

In one example, the terminal may be a smart phone. For the smart phone with a touch screen, the virtual keyboard displayed on the screen may include 26 letters, 10 figures, and the predefined keys (i.e., the left shift key, right shift key, and the determination key). The left shift key may be a left arrow key and the right shift key may be a right arrow key. Thus, the user can input the account/password consisting of letters and/or figures through clicking the predefined keys. For example, when the virtual keyboard is displayed, one letter may be in a selected state in default. At this time, if the user clicks the determination key, the default letter is input to the inputting box. If the user does not want to select the default letter, the user can click the right shift key or the left shift key to select other letters or figures.

In various embodiments, the terminal may be a personal computer or a cell phone with a physical keypad. For the personal computer or the cell phone with physical keypad, the virtual keyboard displayed on a screen may include 26 letters and 10 figures. In these examples, the virtual keyboard displayed on the screen does not include the predefined keys. The predefined keys may correspond to keys on the public keyboard of the personal computer or the cell phone. For example, the right shift key corresponds to the left arrow key on the public keyboard, the right shift key may correspond to the right arrow key on the public keyboard, and the determination key corresponds to a key between the left arrow key and the right arrow key on the public keyboard. Alternatively, the left shift key may be numeric key 4, the determination key may be the numeric key 5, and the right shift key may be the numeric key 6. It should be noted that the present disclosure is not restricted to this.

In block S202, after calling the virtual keyboard, the background program of the terminal configures the predefined keys of the virtual keyboard to the working state and configures keys other than the predefined keys to the disabled state, i.e., lock keys other than the predefined keys on the virtual keyboard. Thus, the user can only input information through clicking the predefined keys.

At block S203, information is input in the inputting box using predefined keys of the virtual keyboard.

In block S203, if the inputting box is an account inputting box, the background program of the terminal performs an operation to a current cursor on the screen using the predefined keys on the virtual keyboard, i.e., the left shift key, right shift key and the determination key, so as to realize account information input. If the inputting box is a password inputting box, the background program of the terminal performs an operation to a current cursor on the screen using the predefined keys on the virtual keyboard, i.e., the left shift key, right shift key and the determination key, so as to realize password information input.

The present disclosure is not restricted to call the virtual keyboard when the account information or password information is input. In order to avoid the leakage of user information due to tapping of the public keyboard, the virtual keyboard may also be utilized to detect the input of other information.

In various embodiments, the state of the inputting box is monitored. When it is detected that the inputting box is in the active state, the virtual keyboard is called. According to the predefined keys of the virtual keyboard, information is input in the inputting box. The various embodiments detect information input via calling a virtual keyboard, instead of using a public keyboard (i.e., a physical keyboard or a system keyboard of the terminal). Thus, the leakage of user information due to being tapped through the public keyboard can be avoided. The security level of the user information is increased.

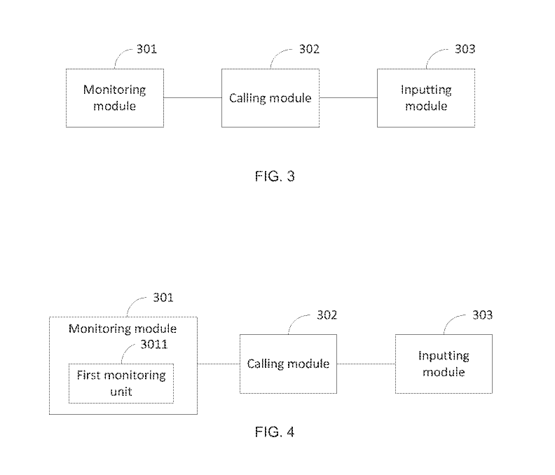

FIG. 3 is a diagram illustrating a structure of an apparatus for inputting information according to various embodiments of the present disclosure. In this example, the apparatus implementing the input of information may be a terminal, such as a cell phone or a personal computer (PC), a functional module, or an application program of the terminal, which is not restricted in the present disclosure.

In various embodiments, a predefined application refers to an application program installed in the terminal. The application program may be a system embedded in application software of the terminal or application software downloaded and installed by the terminal. When using the application software, a user needs to input the account/password. For example, the application software has a communication function or a browsing function.

A background program in this embodiment refers to a program that users cannot reach directly. It may be a program loaded when system starts for implementing operations such as monitoring the predefined application program, calling the virtual keyboard, or inputting information.

The apparatus for inputting information includes the following:

a monitoring module 301, adapted to monitor a state of an inputting box, wherein the state includes an active state or a sleep state;

a calling module 302, adapted to call a virtual keyboard if it is detected that the inputting box is in the active state; and

an inputting module 303, adapted to input information in the inputting box according to predefined keys of the keyboard.

In various embodiments, the monitoring module 301 further includes: a first monitoring unit 3011, as shown in FIG. 4, which is a diagram illustrating a structure of the apparatus for inputting information according to another example of the present disclosure.

The first monitoring unit is adapted to monitor whether there is a predefined application program that performs an activation operation to the inputting box and determine that the inputting box is in the active state if there is in fact a predefined application program that performs an activation operation to the inputting box.

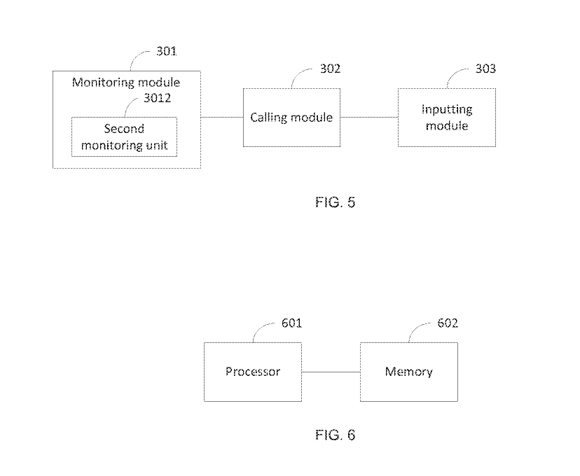

Alternatively, the monitoring module 301 may include a second monitoring unit 3012, as shown in FIG. 5, which is a diagram illustrating a structure of the apparatus for inputting information according to another example of the present disclosure. The second monitoring unit 3012 is adapted to monitor whether a keyboard calling command transmitted by the predefined application program is received and determine that the inputting box is in the active state if a keyboard calling command transmitted by the predefined application program is in fact received.

In various embodiments, the inputting box includes an account inputting box or a password inputting box. The inputting module 303 includes the following:

a first inputting unit adapted to input account information in the account inputting box using the predefined keys on the virtual keyboard; or

a second inputting unit adapted to input password information in the password inputting box using the predefined keys on the virtual keyboard.

In various embodiments, in addition to the calling module 301 and the inputting module 302, the apparatus may further include a configuring module.

The configuring module is adapted to configure, before information is inputted in the inputting box using the predefined keys of the virtual keyboard, the predefined keys on the virtual keyboard to a working state, and configure keys other than the predefined keys to a disabled state.

In various embodiments, the predefined keys include a left shift key, a determination key, and a right shift key.

In various embodiments, the determination key is respectively adjacent to the left shift key and the right shift key.

In various embodiments, the state of the inputting box is monitored. When it is detected that the inputting box is in the active state, the virtual keyboard is called. Using the predefined keys of the virtual keyboard, information is input in the inputting box. The example of the present disclosure detects information input via calling a virtual keyboard, instead of using a public keyboard (i.e., a physical keyboard or a system keyboard of the terminal). Thus, the leakage of user information due to being tapped through the public keyboard can be avoided. The security level of the user information is increased.

FIG. 6 is a diagram illustrating a structure of a terminal according to various embodiments of the present disclosure. The terminal includes one or more processors 601, a memory 602; and one or more program modules stored in the memory 602 and executable by the one or more processors 601; wherein the one or more program modules include instructions for performing the following acts of:

monitoring a state of an inputting box, wherein the state includes an active state or a sleep state;

if it is detected that the inputting box is in the active state, calling a virtual keyboard; and

inputting information in the inputting box using predefined keys of the virtual keyboard.

In various embodiments, instructions for performing the following operations are further included:

monitoring whether an activation operation is performed to the inputting box by an application program;

if it is monitored that the predefined application program activates the inputting box, determining that the inputting box is in the active state.

In various embodiments, instructions for performing the following operations are further included:

determining whether a keyboard calling command transmitted by an application program is received;

if the keyboard calling command transmitted by the predefined application program is received, determining that the inputting box is in the active state.

In various embodiments, instructions for performing the following operations are further included:

inputting account information in the inputting box using the predefined keys of the virtual keyboard, wherein the inputting box is an account inputting box; or

inputting password information in the inputting box using the predefined keys of the virtual keyboard; wherein the inputting box is a password inputting box.

In various embodiments, instructions for performing the following operations are further included:

configuring the predefined keys of the virtual keyboard to a working state and configuring keys other than the predefined keys of the virtual keyboard to a disabled state.

In various embodiments, the predefined keys include a left shift key, a determination key, and a right shift key.

In various embodiments, the state of the inputting box is monitored. When it is detected that the inputting box is in the active state, the virtual keyboard is called. According to the predefined keys of the virtual keyboard, information is input in the inputting box. The example of the present disclosure detects information input via calling a virtual keyboard, instead of using a public keyboard (i.e., a physical keyboard or a system keyboard of the terminal). Thus, the leakage of user information due to being tapped through the public keyboard can be avoided. The security level of the user information is increased.

Various embodiments provide a non-transitory computer readable storage medium, including a set of instructions executable by one or more processors to the input information method. The storage medium may be a computer readable memory, such as a disk or compact disk. The method includes the following:

monitoring a state of an inputting box, wherein the state includes an active state or a sleep state;

if it is detected that the inputting box is in the active state, calling a virtual keyboard; and

inputting information in the inputting box using predefined keys of the virtual keyboard.

In various embodiments, the monitoring the state of the inputting box includes the following:

monitoring whether an activation operation is performed to the inputting box by an application program;

if it is monitored that the predefined application program activates the inputting box, determining that the inputting box is in the active state.

In various embodiments, the monitoring of the state of the inputting box includes the following:

determining whether a keyboard calling command transmitted by an application program is received;

if the keyboard calling command transmitted by the predefined application program is received, determining that the inputting box is in the active state.

In various embodiments, the inputting information in the inputting box using the predefined keys of the virtual keyboard includes the following:

inputting account information in the inputting box using the predefined keys of the virtual keyboard, wherein the inputting box is an account inputting box; or

inputting password information in the inputting box using the predefined keys of the virtual keyboard, wherein the inputting box is a password inputting box.

In various embodiments, before inputting information in the inputting box using the predefined keys of the virtual keyboard, the method further includes the following:

configuring the predefined keys of the virtual keyboard to a working state, and configuring keys other than the predefined keys of the virtual keyboard to a disabled state.

In various embodiments, the predefined keys include a left shift key, a determination key, and a right shift key.

In various embodiments, the state of the inputting box is monitored. When it is detected that the inputting box is in the active state, the virtual keyboard is called. According to the predefined keys of the virtual keyboard, information is input in the inputting box. This example of the present disclosure detects information input via calling a virtual keyboard, instead of using a public keyboard (i.e., a physical keyboard or a system keyboard of the terminal). Thus, the leakage of user information due to being tapped through the public keyboard can be avoided. The security level of the user information is increased.

It should be noted that the examples of the present disclosure are described progressively. For each example, differences of the examples with respect to other examples is described with emphasis. Detailed descriptions of other parts of this example may be seen from other examples. For the apparatus examples, detailed functions and operations of the modules may be seen from corresponding method examples.

It should be noted that, terms such as “first”, “second” are merely used to differentiate one entity or operation from another, but not denote any sequence order or relationship between the entities or operations. The term “includes” means includes but not limited to, the term “including” means including but not limited to. The term “based on” means based at least in part on. In addition, the terms “a” and “an” are intended to denote at least one of a particular element.

Those with ordinary skill in the art would know that all or some of the blocks of the present disclosure may be implemented by hardware, or implemented by a program executed on a relevant hardware. The program may be stored on a computer readable storage medium.

What has been described and illustrated herein is a preferred example of the disclosure along with some of its variations. Many variations are possible within the scope of the disclosure, which is intended to be defined by the following claims—and their equivalents—in which all terms are meant in their broadest reasonable sense unless otherwise indicated.

The foregoing description of the various embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for inputting information, comprising:
monitoring, by a terminal, a state of an inputting box, wherein the state comprises an active state or a sleep state;
if the terminal monitors that the inputting box is in the active state, calling a virtual keyboard; and
inputting, by the terminal, information in the inputting box using predefined keys of the virtual keyboard.

2. The method of claim 1, wherein the monitoring the state of the inputting box comprises:
monitoring, by the terminal, whether there is a predefined application program performs an activation operation to the inputting box; and
if it is monitored that there is a predefined application program performs an activation operation to the inputting box, determining that the inputting box is in the active state.

3. The method of claim 1, wherein the monitoring the state of the inputting box comprises:
monitoring, by the terminal, whether a keyboard calling command transmitted by a predefined application program is received; and
if the keyboard calling command transmitted by the predefined application program is received, determining that the inputting box is in the active state.

4. The method of claim 1, wherein the inputting information in the inputting box using the predefined keys of the virtual keyboard comprises:
inputting, by the terminal, account information in the inputting box using the predefined keys of the virtual keyboard, wherein the inputting box is an account inputting box; or
inputting, by the terminal, password information in the inputting box using the predefined keys of the virtual keyboard, wherein the inputting box is a password inputting box.

5. The method of claim 1, further comprising:
before inputting information in the inputting box using the predefined keys of the virtual keyboard,
configuring, by the terminal, the predefined keys of the virtual keyboard to a working state, and configuring keys other than the predefined keys on the virtual keyboard to a disabled state.

6. The method of claim 1, wherein the predefined keys comprises a left shift key, a determination key and a right shift key.

7. A terminal, comprising: one or more processors, and one or more program modules stored in a memory, wherein the one or more program modules comprise instructions executable by the one or more processors to perform acts of:
monitoring a state of an inputting box, wherein the state includes an active state or a sleep state;
if it is detected that the inputting box is in the active state, calling a virtual keyboard; and
inputting information in the inputting box using predefined keys of the virtual keyboard.

8. The terminal of claim 7, wherein the one or more program modules further comprise instructions executable by the one or more processors to perform acts of:
monitoring whether an activation operation is performed to the inputting box by an application program;
if it is monitored that the predefined application program activates the inputting box, determining that the inputting box is in the active state.

9. The terminal of claim 7, wherein the one or more program modules further comprise instructions executable by the one or more processors to perform acts of:
determining whether a keyboard calling command transmitted by an application program is received;
if the keyboard calling command transmitted by the predefined application program is received, determining that the inputting box is in the active state.

10. The terminal of claim 7, wherein the one or more program modules further comprise instructions executable by the one or more processors to perform acts of:
inputting account information in the inputting box using the predefined keys of the virtual keyboard, wherein the inputting box is an account inputting box; or
inputting password information in the inputting box using the predefined keys of the virtual keyboard; wherein the inputting box is a password inputting box.

11. The terminal of claim 7, wherein the one or more program modules further comprise instructions executable by the one or more processors to perform acts of:
configuring the predefined keys of the virtual keyboard to a working state, and configuring keys other than the predefined keys of the virtual keyboard to a disabled state.

12. The terminal of claim 7, wherein the predefined keys comprise a left shift key, a determination key and a right shift key.

13. A non-transitory computer readable storage medium, comprising one or more programs executable by one or more processors to perform a method for inputting information, the method comprises:
monitoring a state of an inputting box, wherein the state comprises an active state or a sleep state;
if it is detected that the inputting box is in the active state, calling a virtual keyboard; and
inputting information in the inputting box using predefined keys of the virtual keyboard.

14. The storage medium of claim 13, wherein the monitoring the state of the inputting box comprises:
monitoring whether an activation operation is performed to the inputting box by an application program;
if it is monitored that the predefined application program activates the inputting box, determining that the inputting box is in the active state.

15. The storage medium of claim 13, wherein the monitoring the state of the inputting box comprises:
determining whether a keyboard calling command transmitted by an application program is received;
if the keyboard calling command transmitted by the predefined application program is received, determining that the inputting box is in the active state.

16. The storage medium of claim 13, wherein the inputting information in the inputting box using the predefined keys of the virtual keyboard comprises:
inputting account information in the inputting box using the predefined keys of the virtual keyboard, wherein the inputting box is an account inputting box; or
inputting password information in the inputting box using the predefined keys of the virtual keyboard; wherein the inputting box is a password inputting box.

17. The storage medium of claim 13, further comprising:
before inputting information in the inputting box using the predefined keys of the virtual keyboard, configuring the predefined keys of the virtual keyboard to a working state, and configuring keys other than the predefined keys of the virtual keyboard to a disabled state.

18. The storage medium of claim 13, wherein the predefined keys comprise a left shift key, a determination key and a right shift key.
